(19) United States
(12) Patent Application Publication
(10) Pub. No.: US 2025/0245258 A1
(43) Pub. Date: Jul. 31, 2025

(54) GENERATIVE NATURAL LANGUAGE MODEL AND USER INTERFACE FOR DISPUTED TRANSACTIONS

(71) Applicant: MASTERCARD INTERNATIONAL INCORPORATED, PURCHASE, NY (US)

(72) Inventors: Jeff BULLER, Toronto (CA); Rahul DESHPANDE, Chesterfield, MO (US); Siyuan WANG, Dublin (IE); Theunis Johannes GERBER, Wildwood, MO (US)

(21) Appl. No.: 19/034,554

(22) Filed: Jan. 22, 2025

Related U.S. Application Data
(60) Provisional application No. 63/625,265, filed on Jan. 25, 2024.

(51) Int. Cl. G06F 16/34; G06F 16/334

(52) U.S. Cl. CPC G06F 16/345; G06F 16/3344

(57) ABSTRACT

Presenting a natural language response to a user query for a disputed transaction involves gathering transaction details of the user, sending the transaction details and the query to a generative model, receiving a natural language response from the generative model, and presenting the natural language response to the user in a user interface. The transaction details comprise the transaction and a transaction history of the user. The generative model is trained to present a natural language response to the user about the transaction. The natural language response comprises a datum of the transaction present. Further user interaction involves receives an additional query about the transaction; and presenting an additional natural language response to the user that contain an additional datum of the transaction. Flagging a user for a disputed transaction involves determining is based on a user's natural language answer, transaction history, and a disputed transaction threshold.

### BACKGROUND

Efficiently presenting technical information in a manner that is easily understandable and actionable by non-technical users is a significant challenge in the field of user interface design. Many modern devices, particularly smartphones, computers, and other electronic interfaces, provide access to a wide variety of complex technical functions and data. However, the sheer amount of information available often overwhelms users, particularly those without specialized technical knowledge.

Existing solutions frequently fail to strike a balance between providing sufficient detail to inform decision-making and simplifying the presentation to maintain usability. Non-technical users are often required to navigate through multiple layers of menus, decipher obscure terminology, or interpret raw technical data to perform routine tasks. Such inefficiencies can lead to user frustration, errors, and a lack of engagement with the full functionality of the device. These issues are found when users attempt to dispute transactions in existing user interfaces.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

An example system for presenting a natural language response to a user query comprises: a user interface; a processor; and a computer storage medium storing instructions that are operative upon execution by the processor to: receive, from a user, a query about a transaction; gather, from a transaction database, transaction details of the user, wherein the transaction details comprise the transaction and a transaction history of the user; send the transaction details and the query to a generative model, wherein the generative model is trained to present a natural language response to the user about the transaction; receive, from the generative model, the natural language response, wherein the natural language response comprises a datum of the transaction; present the natural language response to the user in the user interface; and in an iterative fashion: receive at least one additional query about the transaction; and present at least one additional natural language response to the user in the user interface, wherein the at least one additional natural language response comprises an additional datum of the transaction.

An example system for flagging a user for a disputed transaction comprises: a processor; and a computer storage medium storing instructions that are operative upon execution by the processor to: receive, from a user, input for a disputed transaction; gather, from a transaction database, transaction details of the user, wherein the transaction details comprise the disputed transaction and a transaction history of the user, wherein the transaction history comprises a total number of prior disputed transactions by the user and a corresponding outcome to each prior disputed transaction; send the transaction details and the input to a generative model, wherein the generative model is trained to present a natural language response to the user about the disputed transaction; receive, from the generative model, the natural language response, wherein the natural language response comprises a datum of the disputed transaction; present the natural language response in a user interface, wherein the datum of the disputed transaction is presented as an icon; receive, from the user, a natural language answer to the natural language response; automatically determine, based on the natural language answer, the transaction history of the user, and a disputed transaction threshold, a user dispute flag decision, wherein the user dispute flag decision flags the user if the natural language answer and the total number of prior disputed transactions exceed the disputed transaction threshold; and transmit the user dispute flag decision to a transaction processor.

An example method for method for training and operating a generative language model comprises: obtaining natural language embeddings from a database; receiving a transaction prompt instruction from a model training system; receiving transaction details of a user, wherein the transaction details comprise a transaction history of the user and data of a disputed transaction; encoding the transaction details into transaction embeddings; analyzing the transaction embeddings; transforming the natural language embeddings and transaction embeddings into a natural language response according to the transaction prompt instruction; and transmitting the natural language response to a user interface.

### BRIEF DESCRIPTION OF THE DRAWINGS

The present description will be better understood from the following detailed description read considering the accompanying drawings, wherein:

FIG. 1 is a block diagram illustrating an example system for presenting a natural language response in a user interface using a machine-learned model.

FIG. 2 is a flow chart illustrating example operation of the computing device to automatically determine a user dispute flag decision.

FIG. 3 is a flow chart illustrating example operation of the computing device to automatically determine a disputed transaction decision.

FIG. 4 is a flow chart illustrating example operation of the computing device to train and operate a machine-learned model.

FIG. 5 is an example user interface displaying a text-based conversation of a user with a natural language artificial intelligence.

FIG. 6 is an example user interface displaying a continued text-based conversation of a user with a natural language artificial intelligence.

FIG. 7A is an example user interface displaying a transaction summary page.

FIG. 7B is an example user interface displaying an initial transaction dispute element on a transaction summary page.

FIG. 8 illustrates an example computing apparatus according to an embodiment as a functional block diagram.

Corresponding reference characters indicate corresponding parts throughout the drawings. Any of the figures may be combined into a single example or embodiment.

### DETAILED DESCRIPTION

A more detailed understanding can be obtained from the following description, presented by way of example, in conjunction with the accompanying drawings. The entities, connections, arrangements, and the like that are depicted in, and in connection with the various figures, are presented by way of example and not by way of limitation. As such, any and all statements or other indications as to what a particular figure depicts, what a particular element or entity in a particular figure is or has, and any and all similar statements, that can in isolation and out of context be read as absolute and therefore limiting, can only properly be read as being constructively preceded by a clause such as “In at least some examples, . . . ” For brevity and clarity of presentation, this implied leading clause is not repeated ad nauseum.

Existing user interfaces provide a barrier to entry for many non-technical users. Traditional graphical user interfaces (GUIs) of programs depend on a user's knowledge and experience to understand the purpose of elements presented on a display. This issue is compounded when a program requires subject-matter expertise to use the program. Icons or elements might be labelled with subject-matter specific terminology that are not readily understood by non-technical users. The presentation of information not known to non-technical users in a GUI often requires that the user spend additional time researching the meaning of unknown terms or otherwise attempt to proceed through the program through trial and error. The additional mental resources and research needed to use the program causes additional friction and time spent using the program that results in a wastage of computing resources.

Furthermore, information may be presented in an unintuitive way to non-technical users, which requires the users to search for the information that they are looking for. For example, a user reading through a list of options that are not arranged in a manner ranked by a metric that is important to the user requires the user to parse through each option to determine that ranking themselves. Additional mental load is placed on the user to understand the sought metric, especially if the user lacks subject-matter knowledge or expertise, thereby causing additional friction and time spent using the program. These user-interface issues are at least found when non-technical users mistakenly dispute valid transactions. Repeated interactions of the users with the computing device, e.g., in search of relevant options, render additional processing load on the computing device.

In contrast to the difficulty for non-technical users to understand GUI elements presented as subject-matter specific terminology or icons, natural language explanations offer a way for non-technical users to interact with subject-matter specific programs. Generative pre-trained transformers (GPTs) can now provide clear and concise explanations to users in the form of natural language. A user can simply enter in a prompt as if speaking or writing to another person and the program can generate a cognizable response. GPTs by themselves, however, cannot provide subject-matter specific explanations accurately. Additional analyses may be required to shape the GPT's responses into accurate and actionable information for the user.

The shortcomings of user interfaces (UIs) and the benefits of natural language explanations are shown when users mistakenly dispute transactions that they do not recognize. Traditional transaction listing UIs include a long alphanumeric code as a transaction identifier. The transaction identifier is provided to the user in addition to the date of the transaction. While in some cases, the transaction identifier includes a name of the entity that the user transacted with, in many cases, the transaction identifier yields little useful information to non-technical users. Often the identifier includes a shortened version of the entity's name or an acronym that requires subject-matter specific knowledge to recognize.

In contrast, a technical solution to the technical problems of traditional transaction listing UIs includes a generative artificial intelligence (AI) interface that converses with a user in natural language about a disputed transaction. The generative AI provides details of the transaction incrementally, or otherwise in a tiered, partial, or step-wise manner, so as not to overwhelm the user. This enables a user to withdraw a submitted transaction dispute themselves (or prevent a dispute from being submitted), which saves computational resources and network traffic on a transaction dispute appeal, thus improving the functioning of the underlying computing device.

Further, aspects of the disclosure improve the usability of the underlying device at least by automatically flagging a user if they exceed a transaction dispute threshold, triggering heightened surveillance measures that are more computationally expensive. Since the surveillance measures are only triggered for users that have exceeded the threshold, and are thus likely fraudulently disputing transactions, the computational resources expended are reduced by being limited to only those users exceeding the threshold. In this manner, the computation resources are conserved and expended only when determined to be necessary.

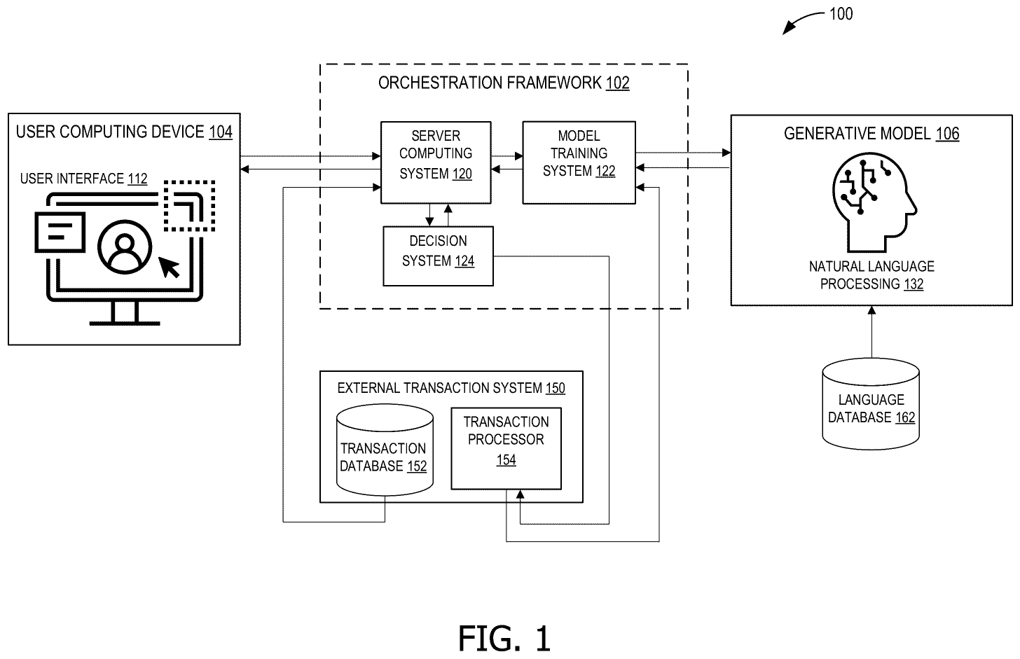

Referring to FIG. 1, an example block diagram illustrates a system 100 of an orchestration framework 102 comprising a computer storage medium. The computer storage medium stores instructions for training and operating a generative model 106, presenting natural language responses on a UI 112, automatically determining a disputed transaction decision, and automatically determining a user dispute flag decision. The orchestration framework 102 can at least comprise multiple computing devices, virtual modules, data stores, processor instructions, program processes, models, GPTs, user interfaces, and data structures. The computer storage medium storing instructions can represent any type of computing device/computer storage device executing instructions, such as application programs, operating system functionality, or both. The computing device, in some examples includes a mobile computing device or any other portable device. A mobile computing device includes, for example but without limitation, a mobile telephone, laptop, tablet, computing pad, netbook, gaming device, and/or portable media player. The computing device can also include less-portable devices such as servers, desktop personal computers, kiosks, or tabletop devices. Additionally, the computing device can represent a group of processing units or other computing devices.

In some examples, the orchestration framework 102 comprises a server computing system 120, a model training system 122, and a decision system 124. The systems of the orchestration framework 102 are operatively connected to one another. The server computing system 120 is operatively connected to a user computing device 104, such as via an internet or network connection. The model training system 122 is similarly operatively connected to a generative model 106. The model training system 122 is also operatively connected to a transaction processor 154 of an external transaction system 150. The server computing system 120 is also operatively connected to a transaction database 152 of the external transaction system 150. Finally, the decision system 124 is operatively connected to the transaction processor 154 of the external transaction system 150.

The orchestration framework 102 trains and operates a generative model 106 for presenting natural language responses in a UI 112. The model training system 122 receives transaction prompt instructions from the transaction processor 154 to train the generative model 106. The generative model 106 is a machine-learned model that is capable of generating natural language responses based on user inputs. In some embodiments, the transaction prompt instructions contain a set of defined natural language prompts that are the desired natural language outputs from the machine-learned model. In at least one example, the model training system 122 evaluates outputs of the generative model 106 and scores the outputs based on the transaction prompt instructions. Scoring the generative model's 106 outputs improves the quality of the natural language responses.

The generative model 106 receives natural language embeddings from a language database 162 for training. The natural language embeddings are machine-readable vector data representing words. The generative model 106 performs natural language processing 132 to encode, transform, and decode user inputs and orchestration framework-provided transaction data into natural language responses. The generative model 106 can be implemented using various generative model techniques and can comprise multiple sub-models to perform the operation of natural language processing 132.

The server computing system 120 of the Orchestration framework 102 receives a user input from a user operating a user computing device 104. In some embodiments, the user input is a transaction dispute. In at least one embodiment, the user input includes a natural language explanation of the user for disputing a specific transaction. The server computing system 120 receives transaction details of the user from a transaction database 152. The transaction details comprise data of the disputed transaction and a transaction history of the user. The server computing system 120 sends the transaction details and the user input to the generative model 106 to generate a natural language response.

The generative model 106 performs natural language processing 132 to encode, transform, and decode the user input and transaction details into a natural language response. The server computing system 120 then receives the natural language response and presents it in a UI 112 on the user computing device 104. In some embodiments, a datum of the transaction details in the natural language response is presented as an icon. To the user, it appears as if a generative AI is conversing in natural language about the disputed transaction.

The user then responds to the natural language response in a natural language answer. In most cases, the user either cancels the transaction dispute or insists that they do not recognize the disputed transaction. The server computing system 120 sends the user's natural language answer to the generative model 106 for further natural language processing 132. The process of the user inputting natural language, the system 120 sending the user input to the generative model 106, the generative model 106 providing a natural language response, and the system 120 sending the response to the UI 112 repeats based on the conversation. In at least one embodiment, later responses from the generative model 106 include additional transaction details about the disputed transaction.

In some implementations, the transaction prompt instructions contain an order for presenting certain types of transaction details data to a user in the natural language responses. For example, presenting basic transaction details data (e.g., transaction time, type, amount, etc.) before tertiary transaction details data (e.g., device name that performed transaction, location of device that performed transaction, method that transaction was performed, etc.). In this example, basic details are associated with the transaction itself while tertiary details are associated with the device or account that performed the transaction. Another order is complexity, where more-simple transaction details such as transaction date, subject summary, or a simplified transaction entity name are presented before more-complex transaction details such as transaction time (to the minute or second), a full description of the transaction subject, or a full entity name. The orders help to ease the user into understanding the transaction details without overloading them with information, thereby improving the human-computer interaction.

The transaction details data can also be presented in order of sensitivity. The transaction details data can have a sensitivity value (e.g., sensitivity levels 1-10, A through F, none to high, etc.) so that the different types of transaction details have a sensitivity hierarchy. In addition, the transaction details data can have a sensitivity classifier (e.g., proprietary, confidential, sensitive, etc.) that In at least one example, the sensitivity classifier is a binary designation of personally identifiable information (PII) and non-PII data. Depending on the implementation, PII can include any of a user's name, a name of a family member of the user, an address, a phone number, an email address, or an identification number, for example.

In some versions, the natural language responses incrementally present the transaction details data in ascending order of sensitivity (e.g., from less sensitive to more sensitive). For example, an initial natural language response does not show data above a minimal sensitivity (e.g., only shows data deemed or designated to be at or below minimal sensitivity), the second response does not show data above a low sensitivity (e.g., only shows data deemed or designated to be at or below low sensitivity), and so on. In some implementations, subsequent natural language responses do not include high or medium sensitivity data unless a prior natural language response includes medium or low sensitivity data respectively. In one example, a first instance of a natural language response states a transaction amount, a date, a time, and a descriptor name of the transaction.

In some examples, a second instance of a natural language response comprises contact information associated with the transaction, such as an email address and phone number of a transactor of the transaction. In some embodiments, the second instance also comprises a product name, product quantity, and amount of the transaction. In some implementations, the preceding data is classified as low sensitivity data.

Continuing, in some examples, a third instance of a natural language response displays a location where the transaction was made. The location is preferably shown as a map of the area of the transaction. In at least one embodiment, the third instance displays a device name and device type that the transaction was made from. In some implementations, the preceding data is classified as moderate sensitivity data.

Similarly, in some examples, a fourth instance of a natural language response states a listing of prior transactions of the user that were made with the same entity, the device name that made those transactions, the corresponding dates and transaction amounts. In some implementations, the preceding data is classified as high sensitivity data. Training the generative model 106 to stagger the information it presents to a user reduces the mental load of the user preventing them from being overwhelmed by the response. Incrementally presenting the transaction detail data in ascending order of sensitivity improves a user's comfort when shown transaction detail data.

In some versions, the natural language responses present the transaction details according to multiple types of orders. For example, the natural language responses could present “low” sensitivity transaction details data in order from basic to tertiary before presenting “medium” sensitivity transaction details data also in order from basic to tertiary. Combining multiple types of orderings enables the benefits of each ordering type.

In some examples, the decision system 124 analyzes the user input and transaction details to determine a user dispute flag decision. The decision system 124 automatically determines whether to flag the user based on the natural language answer, the transaction history of the user, and a disputed transaction threshold. The decision system 124 compares the total number of prior disputed transactions and the current transaction dispute to the disputed transaction threshold. If the disputed transaction threshold is exceeded, the decision system 124 flags the user. The decision system 124 then transmits the user dispute flag decision to the transaction processor 154. Flagging the user can automatically trigger multiple actions. In some examples, for a flagged user, the external transaction system 150 automatically engages heightened surveillance measures to monitor the user's actions for suspicious behavior. These heightened surveillance measures can be computationally expensive, so automatically triggering them on condition of the flag for exceeding the transaction dispute threshold serves to preserve computational resources. Additional actions can include rejecting the transaction dispute, automatically warning entities that the user frequently transacts with, or suspending a transaction account of the user.

In some embodiments, the decision system 124 also analyzes the user input and transaction details to determine a disputed transaction decision. The decision system 124 compares the transaction details with a formula to make the decision. The decision system 124 can also receive details about the user computing device 104 as part of the decision. For example, if an identifier of the user computing device 104 and a device that performed a transaction are identical, the decision system 124 can reject the transaction dispute. In other embodiments, the decision system 124 can apply different weights to the data of the transaction details and reject the disputed transaction if the combined weights are above a certain threshold. The decision system 124 transmits the user disputed transaction decision to the transaction processor 154.

The conversation can conclude in multiple ways, such as by the user abstaining from answering for a certain amount of time, the generative model 106 reaching the end of presentable transaction details, or the decision system 124 rejecting the transaction dispute. After the conversation concludes, the server computing system 120 sends all of the user inputs, any decisions from the decision system 124, and all of the natural language responses to the generative model 106 to generate a summary of the disputed transaction in natural language. The decision system 124 then sends the summary of the disputed transaction to the transaction processor 154. In some embodiments, the server computing system 120 also sends the transaction summary along with a final natural language response to the user. This allows the user to read a concise summary of the conversation without needing to re-read the entire conversation. The final natural language response can also include the transaction dispute decision as well as instructions for appealing the decision with the transaction processor 154.

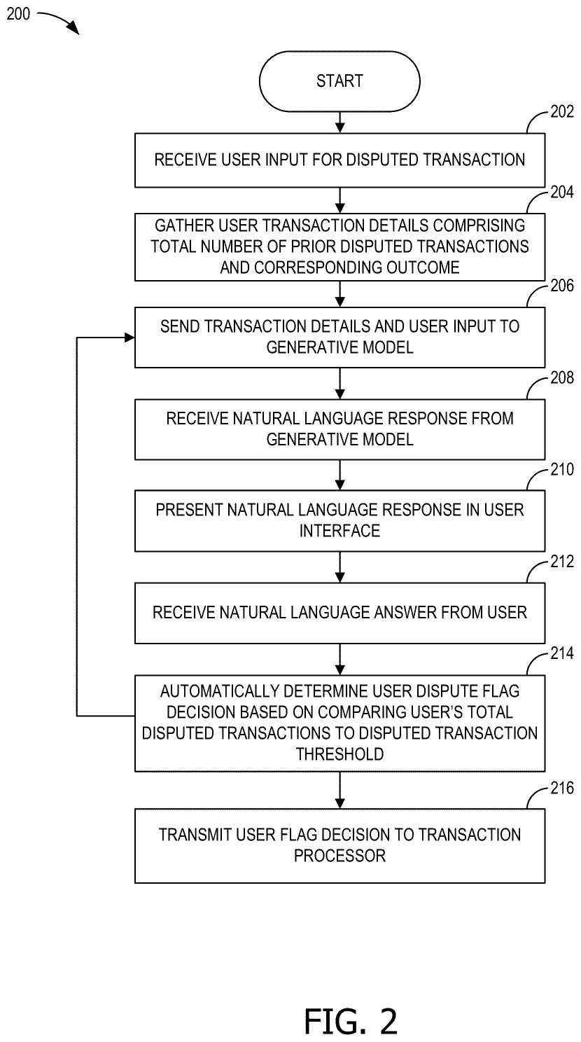

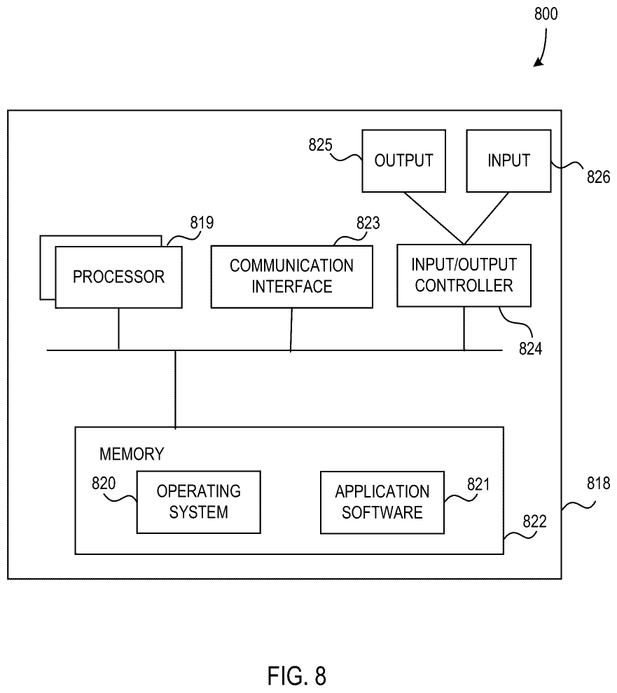

FIG. 2 is an example flow chart 200 illustrating operation of the computing device for automatically determining a user dispute flag decision. The process shown in FIG. 2 is implemented by an orchestration framework executing on a computing device, such as, but not limited to, the computer apparatus 818 of FIG. 8. The process of flow chart 200 automatically determines the user dispute flag decision based on a natural language conversation the computing device performs with the user.

The process begins with receiving input from a user for a disputed transaction at 202. In some embodiments, the user input is forwarded from a transaction processor to the computing device when a user disputes a transaction. For example, the user interacting with a user interface of the transaction processor to initiate a transaction dispute process sends the user's input to the computing device to process the disputed transaction. In further embodiments, the user input comprises a natural language comment from the user as an initial summary of the reason for the user disputing the transaction.

The process continues with gathering transaction details of the user from a transaction database at 204. The transaction details comprise the disputed transaction and a transaction history of the user. The disputed transaction includes any relevant data or metadata corresponding to the transaction. In various embodiments, the transaction history comprises a total number of prior disputed transactions by the user and a corresponding outcome to each prior disputed transaction. The corresponding outcome can be a decision by a transaction processor to accept or reject the respective prior disputed transaction. In at least one example, the transaction database is from an external transaction system distinct from the computing device.

Next, the process sends the transaction details and the user input to a generative model, such as a GPT, at 206. The generative model is trained to present a natural language response to the user about the disputed transaction. In various examples, the generative model is capable of encoding the user's initial input and later answers into embeddings, transforming the embeddings, and then decoding the embeddings into a natural language response. In some embodiments, the generative model comprises multiple sub-models to perform the encoding, transforming, and decoding functions.

Then, the process receives a natural language response from the generative model at 208. The natural language response is generated by the generative model and is a function of the transaction details, the user input, and the generative model's training. In various embodiments, the natural language response includes a datum of the disputed transaction in the natural language response. The disputed transaction data corresponds to data of the transaction, such as the date and time of the transaction, a geographic location of the transaction, a name/type of device used to make the transaction, or other transactions with the same entity as the disputed transaction.

In some embodiments, the natural language response is an explanation in favor of the validity of the disputed transaction. The datum of the disputed transaction is designed to inform the user of the details of the disputed transaction. Informing the user of the disputed transaction details has the benefit of reminding the user that they initiated the disputed transaction, and that it is thus valid.

Next, the process presents the natural language response in a UI at 210. The natural language response is viewable in the UI by the user. Where the natural language response includes a datum of the disputed transaction, the datum can be presented as an icon. The UI can be a GUI. The icons can be images, text descriptions, some combination of both, or some other visual representations.

Continuing, the process receives a natural language answer to the natural language response from the user at 212. The user's natural language answer is the user's response to the information contained in the generative model's explanation of the disputed transaction. The natural language answer includes a user's decision to cancel the dispute transaction process, such as by clicking on a UI element indicating such or by failing to respond to the natural language answer within a timeout window.

Then, the process automatically determines a user dispute flag decision at 214. The user dispute flag decision is based on the natural language answer of the user, the transaction history of the user, and a disputed transaction threshold. The user dispute flag decision is a decision whether to flag the user if the user's natural language answer and the total number of prior disputed transactions exceed the disputed transaction threshold. In various embodiments, the generative model encodes the user's natural language answer into a machine-readable format for the computing device. In at least one embodiment, the disputed transaction threshold is set by the transaction processor.

Flagging a user for exceeding the dispute transaction threshold is an important analytical tool. A direct consequence of being flagged could be the cancellation of a user account or the immediate rejection of any disputed transactions. Alternatively, the flag might place the user under heightened scrutiny that might automatically trigger additional oversight measures for future transactions with the user. These additional oversight measures require additional computational and network resources. Automatically flagging a user once they exceed a disputed transaction threshold saves computational resources for the transaction processor since the measures only need to be employed when the user has disputed enough transactions as to become suspicious of fraud.

In some embodiments, the computing device can also automatically determine whether to continue to converse with the user. The computing device sends the user's natural language answer as a user input back to the generative model at 206.

Finally, the process transmits the user dispute flag decision to a transaction processor at 216. In addition to the dispute flag decision, the natural language responses of the generative model and the user's input and answers can also be transmitted.

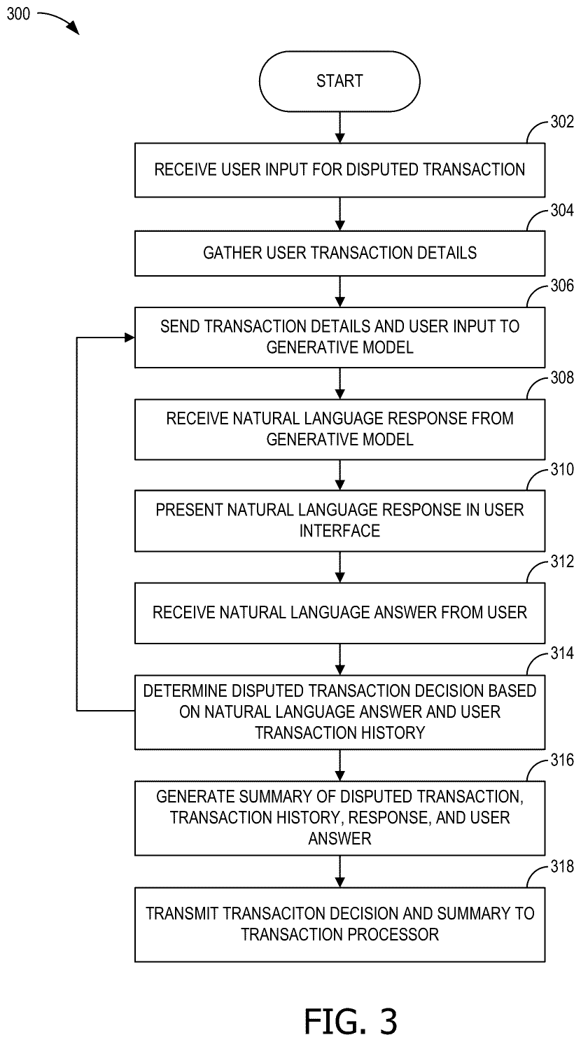

FIG. 3 is an example flow chart 300 illustrating operation of the computing device for automatically determining a disputed transaction decision. The process shown in FIG. 3 is implemented by an orchestration framework executing on a computing device, such as, but not limited to, the computing apparatus 818 of FIG. 8. The process of flow chart 300 automatically determines a disputed transaction decision of whether to approve or reject a disputed transaction based on a natural language conversation the computing device performs with the user.

The process begins with receiving input from a user for a disputed transaction at 302. Operation 302 is identical to operation 202 discussed above. The process continues with gathering transaction details of the user from a transaction database at 304. The transaction details comprise the disputed transaction and a transaction history of the user. The disputed transaction includes any relevant data or metadata corresponding to the transaction. In at least one example, the transaction database is from an external transaction system distinct from the computing device. In at least one embodiment, operation 304 is identical to operation 204 discussed above.

Next, the process sends the transaction details and the user input to a generative model, such as a GPT, at 306. Operation 306 is identical to operation 206 discussed above. Then, the process receives a natural language response from the generative model at 308. Operation 308 is identical to operation 208 discussed above. Next, the process presents the natural language response in a UI at 310. Operation 310 is identical to operation 210 discussed above. Continuing, the process receives a natural language answer to the natural language response from the user at 312. Operation 312 is identical to operation 212 discussed above.

Then, the process automatically determines a disputed transaction decision at 314. The disputed transaction decision is based on the natural language answer of the user and the transaction history of the user. The disputed transaction decision is a decision whether to accept or reject the disputed transaction of the user. In various embodiments, the generative model encodes the user's natural language answer into a machine-readable format for the computing device. In some embodiments, the computing device can also automatically determine whether to continue to converse with the user. If so, the computing device sends the user's natural language answer as a user input back to the generative model to continue at 306.

Automatically determining whether to accept or reject the disputed transaction after conversing with the user saves computational resources otherwise spent on analyzing the disputed transaction for signs of fraud. The user is the most likely individual to recognize whether the disputed transaction is actually a valid transaction, so conversing with the user where the user is confronted with the disputed transaction data will save computational resources in many instances where the user decides to cancel the transaction dispute.

Thereafter, the process generates a summary of the disputed transaction at 316. The disputed transaction summary summarizes the transaction history of the user, the natural language response(s), and the natural language answer(s). In some embodiments, the generative model generates the disputed transaction summary in natural language.

If the process rejects the disputed transaction, the user may still have an option to appeal the decision with the transaction processor. In this instance, the disputed transaction summary saves computational resources by providing the most-relevant information to the transaction processor that would otherwise need to be gathered and stored as part of the appeal process. Further, in some automated systems, the disputed transaction summary simplifies the data need to analyze the disputed transaction, thereby improving the operating speed of the computing devices performing the appeal analysis.

Finally, the process transmits the disputed transaction decision and the summary of the disputed transaction to a transaction processor at 318. In addition to disputed transaction decision and the summary of the disputed transaction, each of the natural language responses of the generative model, and the user's input and answers can also be transmitted.

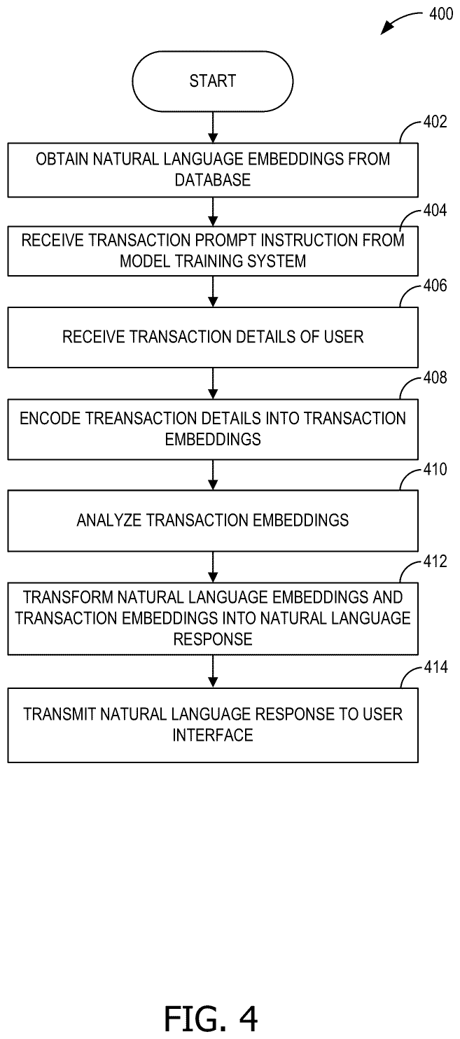

FIG. 4 is an example flow chart 400 illustrating operation of a computing device for training and operating a generative model. The process shown in FIG. 4 is implemented by an orchestration framework executing on a computing device, such as, but not limited to, the Orchestration framework executing on a computing apparatus 818 as shown in FIG. 8.

The process begins with obtaining natural language embeddings from a database at 402. The natural language embeddings are vector data representing words and documents. Similar words and documents are encoded with similar vector data. This allows a machine learning model to perform complex transformations on the vector data to preserve the semantic and syntactic information of the text. In some embodiments, the natural language embeddings can come from an external database.

The process continues with receiving transaction prompt instructions from a model training system at 404. The model training system trains a machine-learned model, such as a generative model, using various training or learning techniques. The transaction prompt instructions are computer-readable instructions that define the expected outputs of the model. In some embodiments, the transaction prompt instructions contain a set of defined natural language prompts that are the desired natural language outputs from the machine-learned model.

The various training or learning techniques can include, for example, backwards propagation of errors. For example, a loss function can be backpropagated through the model(s) to update one or more parameters of the model(s) (e.g., based on a gradient of the loss function). Various loss functions can be used such as mean squared error, likelihood loss, cross entropy loss, hinge loss, and/or various other loss functions. Gradient descent techniques can be used to iteratively update the parameters over a number of training iterations. In some implementations, performing backwards propagation of errors can include performing truncated backpropagation through time. The model training system can perform a number of generalization techniques (e.g., weight decays, dropouts, etc.) to improve the generalization capability of the models being trained.

Next, the process receives transaction details of a user at 406. The transaction details comprise a transaction history of the user and data of a disputed transaction. The transaction history can include a total number of prior disputed transactions by the user and a corresponding outcome to each prior disputed transaction, such as whether it was accepted or rejected. The data of the disputed transaction is transaction data related to the transaction itself, such as, a geographic location of the transaction. Depending on the implementation, other transaction details include, a date of transaction, time of transaction, location of transaction, whether the transaction was online or in person, an amount of the transaction, an item or service purchased, a merchant name, a card present or card-not-present transaction type, or a tap or chip inserted transaction.

The process then encodes the transaction details into transaction embeddings at 408. The transaction embeddings are machine-readable vector representations of the transaction details. One or more models can perform operations 410-414 stated below.

Then, the process analyzes the transaction embeddings at 410 and transforms the natural language embeddings and transaction embeddings into a natural language response according to the transaction prompt instructions at 412.

During and after the training process, the machine-learned model is configured to determine natural language responses to the input requests based on the application of the transaction prompt instruction. During the training process, a request map of the transaction prompt instructions are altered, adjusted, or otherwise changed based on the natural language embeddings, such that, after training is complete, the machine-learned model yields natural language responses that are the same as or at least substantially similar to the responses associated with the transaction prompt instruction. The training of the machine-learned model and associated adjustments made to the map may be based on analysis of the natural language and transaction embeddings, identification of patterns of requests that are associated with particular responses or types of responses, etc. Further, in some examples, the training of the machine-learned model is performed using deep learning classification algorithms and/or other machine learning techniques.

In some examples, the model training system includes a machine learning module that comprises a trained regressor such as a random decision forest, a directed acyclic graph, a support vector machine, a convolutional neural network or other neural network, or another trained regressor. Such a trained regressor may be trained using the transaction details as feedback data. It should further be understood that the machine learning module, in some examples, operates according to machine learning principles and/or techniques known in the art without departing from the systems and/or methods described herein.

In an example, the machine learning module makes use of training data pairs when applying machine learning techniques and/or algorithms. Millions of training data pairs (or more) may be stored in a machine learning data structure. In some examples, a training data pair includes a timestamp-based feedback data value paired with an interval adjustment value. The pairing of the two values demonstrates a relationship between the feedback data value and the adjustment values that may be used by the machine learning module to determine future interval adjustments according to machine learning techniques and/or algorithms.

Finally, the process transmits the natural language responses to a UI at 414. The UI can be a GUI. The icons can be images, text descriptions, some combination of both, or some other visual representations. The process can also present graphical representations of transaction data. The graphical representations can include icons, graphs, tables, figures, diagrams, charts, or other visual images. The icons and graphical representations should preferably be concise explanations or clear visualizations of data. Irrelevant or complex information should not be presented initially on the GUI to reduce the mental load on the user.

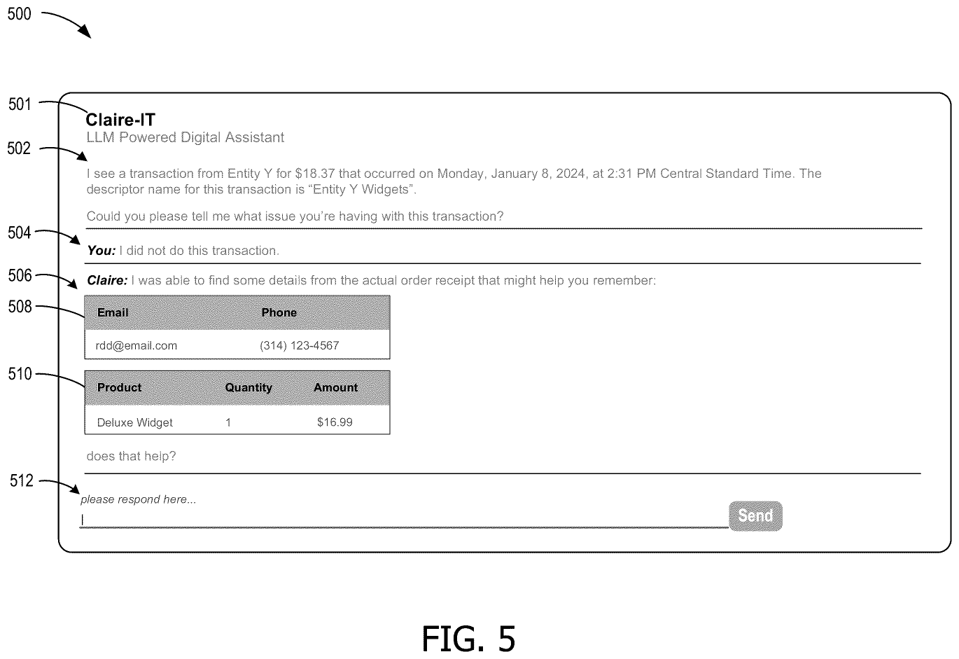

FIG. 5 is an example UI 500 displaying a text-based conversation of a user with a natural language artificial intelligence (AI) 501. The user can interact with the UI 500 using natural language, and the UI 500 produces natural language responses using text and images from the orchestration framework. The user can input any answer to the AI 501 through a text interface 512. The Orchestration framework can be implemented as described above in FIGS. 1-4.

In the example, the user disputes a transaction initiating a transaction dispute process. The user is then presented with the UI 500 with the natural language AI 501. The natural language AI 501 can present natural language responses to the user through the use of a machine-learned model, such as a GPT. The UI 500 and the natural language AI 501 can be implemented according to FIGS. 1-4 above.

After the user initiates a transaction dispute, the AI presents a natural language response 502 which includes transaction details of the disputed transaction. In some embodiments, the natural language response 502 only includes initial transaction details such as a transaction entity, a transaction amount, a time and date of the transaction, and a transaction descriptor name. These initial transaction details can help to remind the user of if the disputed transaction is actually a valid transaction without overloading the user with information.

The user enters a natural language answer 504 to the natural language AI to respond to the natural language response 502. The AI 501 is configured to understand the user's answer and take steps, such as canceling the transaction dispute process or continuing to respond to the user based on the user's answer. In this example, the user denies performing the transaction in the answer 504.

If the user denies performing the transaction or otherwise does not recognize the transaction, the AI 501 presents an additional natural language response 506 that includes more transaction details 508 and 510. In this example, the AI presents an email address and phone number associated with the disputed transaction 508. Additionally, the AI presents a product name, a product quantity, and a product amount 510.

The additional information serves to provide context to the disputed transaction. In many cases, users forget that they performed a transaction or otherwise do not recognize a transaction based on a transaction summary provided to them. The UI 500 and the AI 501 progressively provide more information to the user that a transaction is legitimate. When presented with corroborating information, users will often remember the transaction and cancel the transaction dispute. A user canceling the transaction dispute saves computational resources and network traffic spent on canceling the disputed transaction or appealing the transaction dispute decision.

In examples wherein the user has not yet submitted a transaction dispute, presenting the user with the corroborating information prompts the user to refrain from submitting the transaction dispute. This also saves computational resources and network traffic that would have been spent on disputing the transaction.

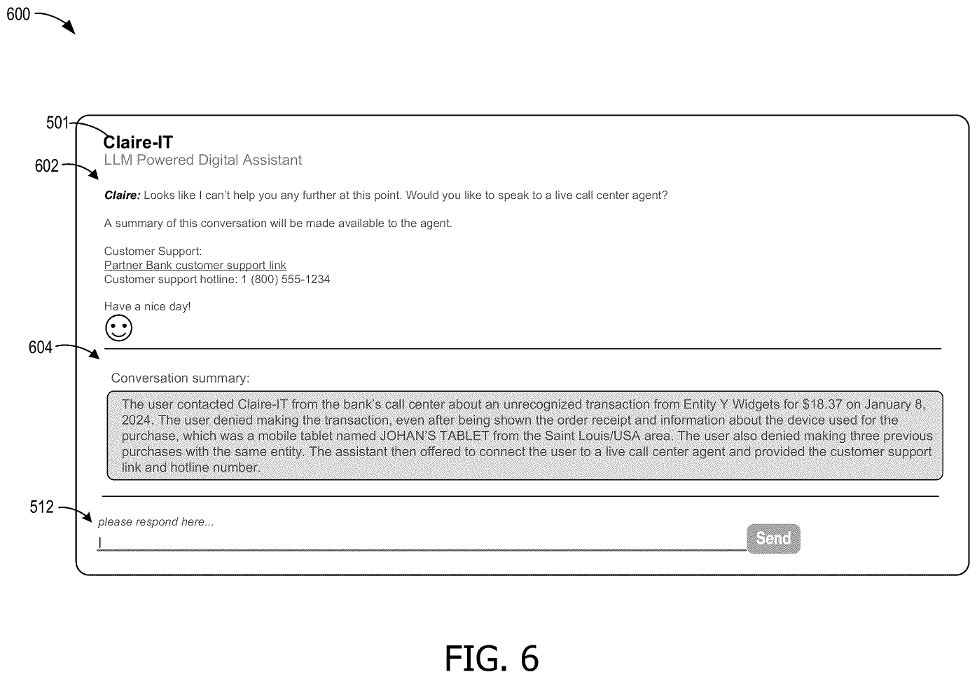

FIG. 6 is an example UI 600 displaying a continued text-based conversation of a user with a natural language AI 501. The user can interact with the UI 600 using natural language in a text-based input, and the UI 600 produces natural language responses using text and images from the orchestration framework. The user can input any answer to the AI 501 through a text interface 512. The orchestration framework can be implemented as described above in FIGS. 1-4. The orchestration framework, the AI 501, and the text interface 512 are the same as FIG. 5 discussed above.

In the example shown in FIG. 6, the user does not cancel the transaction dispute process. The orchestration framework automatically determines a disputed transaction decision, such as shown in FIG. 3. In UI 600, the Orchestration framework's decision rejects the user's transaction dispute. The AI 501 presents a natural language response 602 that the AI 501 can no longer assist the user with the transaction dispute and provides an alternative appeal option with the transaction processor.

The AI 501 also presents a transaction dispute summary 604, such as shown in FIG. 3 to the user. The transaction dispute summary 604 is a summary of the conversation between the user and the AI 501 regarding the transaction dispute. The transaction dispute summary includes transaction details that were presented in natural language responses to the user. In some embodiments, the transaction dispute summary is hidden from the user and transmitted to the transaction processor. If the user enters in any additional input into the text interface 512, that input is also transmitted to the transaction processor.

Presenting the transaction dispute summary 604 to the user reduces the mental load of the user by concisely summarizing relevant information from the conversation. Instead of needing to re-read the conversation with the AI, the user can read the transaction dispute summary 604 instead.

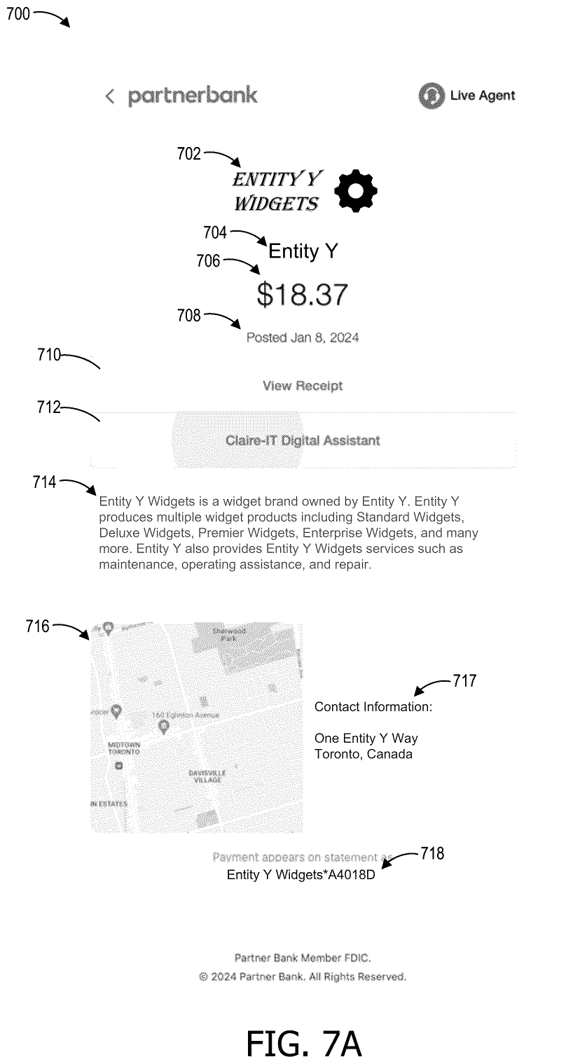

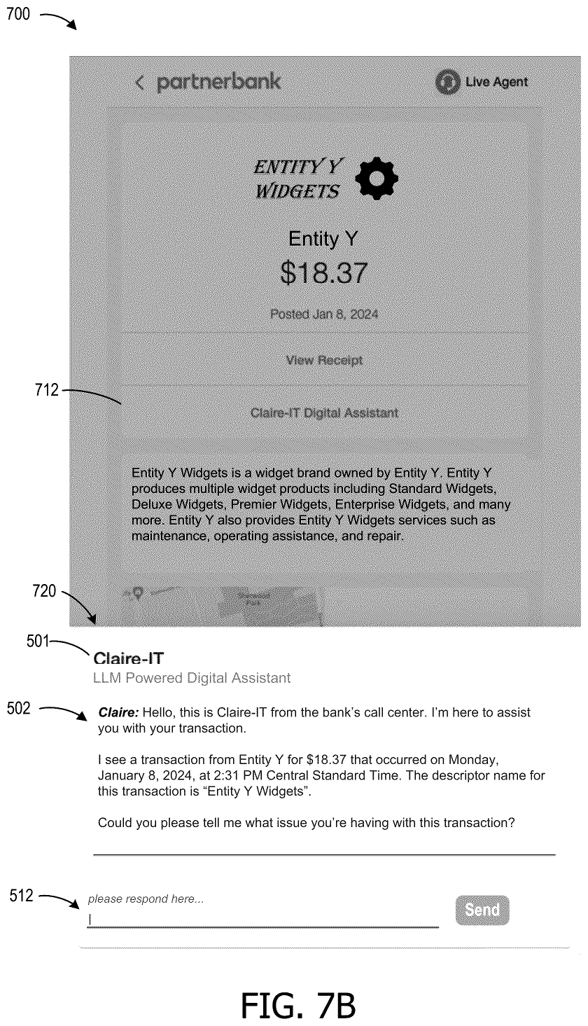

FIG. 7A is an example UI 700 displaying a transaction summary page. In some implementations where a disputed transaction involves a disputed payment, a transaction summary page that displays transaction details and corresponding entity information is presented when a user selects a transaction from a transaction list. The UI 700 includes a UI element to initiate a transaction dispute with a machine-learned AI of the disclosure, such as transaction dispute button. In the example of UI 700 in FIG. 7A, the UI element is “Claire-IT Digital Assistant” 712.

In some examples, the UI 700 presents an entity logo 702, an entity text name 704, a transaction amount 706, and a transaction date 708 of the transaction. These details are the most critical details of a transaction, and are thus preferably presented at the top of the page. The entity logo 702 provides additional context if an entity's logo is purely an image and does not contain any text. In some implementations, the UI 700 includes a view receipt button 710 to view a receipt of the transaction. Finally, the UI 700 can include entity contact information 717, such as a mailing address of the entity (and phone number and/or email address of the entity), for the user to contact the entity directly if they desire.

Also, in some embodiments, the UI 700 includes an alphanumeric code 718 that functions as a transaction identifier. Preferably, the alphanumeric code 718 is presented below other transaction or entity information on the transaction summary page as the meaning of the transaction identifier is unlikely to be understood by many users.

In some implementations, the UI 700 includes an entity summary 714 of the entity of the transaction. The entity summary 714 is a description of the entity and provides context to the user of any products or services commonly offered by the entity. In some embodiments, the entity summary 714 is generated by a GPT, such as the generative model 106 of FIG. 1.

Further, in some embodiments, the UI 700 includes additional information about the entity such as a map showing a location of the transaction 716. The location of the transaction 716 is preferably presented as an image of a map of the location since the technologies that are used to estimate transaction location are often not accurate to a particular physical or mailing address but are accurate within a relatively small geographic area. Presenting a map of the transaction location 716 thus has the benefit of suggesting that a user or a user's device performed the transaction.

FIG. 7B displays an exemplary transaction dispute element 720 of the transaction summary page on UI 700 when a user selects the transaction dispute button 712. In the transaction dispute element 720, an AI 501 presents a natural language response 502, such as discussed above in FIG. 5. The AI 501 is a machine-learned AI that converses with a user in natural language. In some implementations, the transaction dispute element is the UI 500 or UI 600 of FIGS. 5 and 6 respectively.

The AI 501 initially presents the natural language response 502 to initiate a conversation with the user. Preferably, the response 502 is polite and does not indicate that the user is disputing the transaction. Instead, the response preferably recites several transaction details as discussed in FIG. 5 in natural language and includes an invitation for the user to explain what issue they are having with the transaction. The transaction dispute element 720 includes a text or voice-to-text interface 512 for the user to describe what issue they have with the transaction. The user's explanation is a user input as discussed above in FIGS. 1-3.

### Exemplary Operating Environment

The present disclosure is operable with a computing apparatus according to an embodiment as a functional block diagram of a computing system 800 in FIG. 8. In an embodiment, components of a computing apparatus 818 may be implemented as a part of an electronic device according to one or more embodiments described in this specification. The computing apparatus 818 comprises one or more processors 819 which may be microprocessors, controllers, or any other suitable type of processors for processing computer executable instructions to control the operation of the electronic device. Alternatively, or in addition, the processor 819 is any technology capable of executing logic or instructions, such as a hardcoded machine. Platform software comprising an operating system 820 or any other suitable platform software may be provided on the apparatus 818 to enable application software 821 to be executed on the device.

Computer executable instructions may be provided using any computer-readable media that are accessible by the computing apparatus 818. Computer-readable media may include, for example, computer storage media such as a memory 822 and communications media. Computer storage media, such as the memory 822, include volatile and non-volatile, removable, and non-removable media implemented in any method or technology for storage of information such as computer readable instructions, data structures, program modules or the like. Computer storage media include, but are not limited to, RAM, ROM, EPROM, EEPROM, persistent memory, phase change memory, flash memory or other memory technology, CD-ROM, digital versatile disks (DVD) or other optical storage, magnetic cassettes, magnetic tape, magnetic disk storage, shingled disk storage or other magnetic storage devices, or any other non-transmission medium that can be used to store information for access by a computing apparatus.

In contrast, communication media embody computer readable instructions, data structures, program modules, or the like in a modulated data signal, such as a carrier wave, or other transport mechanism. As defined herein, computer storage media do not include communication media. Therefore, a computer storage medium does not include a propagating signal. Propagated signals are not examples of computer storage media. Although the computer storage medium (the memory 822) is shown within the computing apparatus 818, it will be appreciated by a person skilled in the art that the storage may be distributed or located remotely and accessed via a network or other communication link (e.g., using a communication interface 823).

The computing apparatus 818 may comprise an input/output controller 824 configured to output information to one or more output devices 825, for example a display or a speaker, which may be separate from or integral to the electronic device. The input/output controller 824 may also be configured to receive and process an input from one or more input devices 826, for example, a keyboard, a microphone, or a touchpad. In one embodiment, the output device 825 may also act as the input device. An example of such a device may be a touch sensitive display. The input/output controller 824 may also output data to devices other than the output device, e.g., a locally connected printing device. In some embodiments, a user may provide input to the input device(s) 826 and/or receive output from the output device(s) 825.

The functionality described herein can be performed, at least in part, by one or more hardware logic components. According to an embodiment, the computing apparatus 818 is configured by the program code when executed by the processor 819 to execute the embodiments of the operations and functionality described. Alternatively, or in addition, the functionality described herein can be performed, at least in part, by one or more hardware logic components. For example, and without limitation, illustrative types of hardware logic components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), Graphics Processing Units (GPUs).

At least a portion of the functionality of the various elements in the figures may be performed by other elements in the figures, or an entity (e.g., processor, web service, server, application program, computing device, etc.) not shown in the figures.

Although described in connection with an exemplary computing system environment, examples of the disclosure are capable of implementation with numerous other general purpose or special purpose computing system environments, configurations, or devices.

Examples of well-known computing systems, environments, and/or configurations that may be suitable for use with aspects of the disclosure include, but are not limited to, mobile or portable computing devices (e.g., smartphones), personal computers, server computers, hand-held (e.g., tablet) or laptop devices, multiprocessor systems, gaming consoles or controllers, microprocessor-based systems, set top boxes, programmable consumer electronics, mobile telephones, mobile computing and/or communication devices in wearable or accessory form factors (e.g., watches, glasses, headsets, or earphones), network PCs, minicomputers, mainframe computers, distributed computing environments that include any of the above systems or devices, and the like. In general, the disclosure is operable with any device with processing capability such that it can execute instructions such as those described herein. Such systems or devices may accept input from the user in any way, including from input devices such as a keyboard or pointing device, via gesture input, proximity input (such as by hovering), and/or via voice input.

Examples of the disclosure may be described in the general context of computer-executable instructions, such as program modules, executed by one or more computers or other devices in software, firmware, hardware, or a combination thereof. The computer-executable instructions may be organized into one or more computer-executable components or modules. Generally, program modules include, but are not limited to, routines, programs, objects, components, and data structures that perform particular tasks or implement particular abstract data types. Aspects of the disclosure may be implemented with any number and organization of such components or modules. For example, aspects of the disclosure are not limited to the specific computer-executable instructions, or the specific components or modules illustrated in the figures and described herein. Other examples of the disclosure may include different computer-executable instructions or components having more or less functionality than illustrated and described herein.

In examples involving a general-purpose computer, aspects of the disclosure transform the general-purpose computer into a special-purpose computing device when configured to execute the instructions described herein.

An example system for presenting a natural language response to a user query comprises: a user interface; a processor; and a computer storage medium storing instructions that are operative upon execution by the processor to: receive, from a user, a query about a transaction; gather, from a transaction database, transaction details of the user, wherein the transaction details comprise the transaction and a transaction history of the user; send the transaction details and the query to a generative model, wherein the generative model is trained to present a natural language response to the user about the transaction; receive, from the generative model, the natural language response, wherein the natural language response comprises a datum of the transaction; present the natural language response to the user in a user interface; and in an iterative fashion: receive at least one additional query about the transaction; and present at least one additional natural language response to the user, wherein the at least one additional natural language response comprises an additional datum of the transaction.

An example system for flagging a user for a disputed transaction comprises: a processor; and a computer storage medium storing instructions that are operative upon execution by the processor to: receive, from a user, input for a disputed transaction; gather, from a transaction database, transaction details of the user, wherein the transaction details comprise the disputed transaction and a transaction history of the user, wherein the transaction history comprises a total number of prior disputed transactions by the user and a corresponding outcome to each prior disputed transaction; send the transaction details and the input to a generative model, wherein the generative model is trained to present a natural language response to the user about the disputed transaction; receive, from the generative model, the natural language response, wherein the natural language response comprises a datum of the disputed transaction; present the natural language response in a user interface, wherein the datum of the disputed transaction is presented as an icon; receive, from the user, a natural language answer to the natural language response; automatically determine, based on the natural language answer, the transaction history of the user, and a disputed transaction threshold, a user dispute flag decision, wherein the user dispute flag decision flags the user if the natural language answer and the total number of prior disputed transactions exceed the disputed transaction threshold; and transmit the user dispute flag decision to a transaction processor.

An example method for method for training and operating a generative language model comprises: obtaining natural language embeddings from a database; receiving a transaction prompt instruction from a model training system; receiving transaction details of a user, wherein the transaction details comprise a transaction history of the user and data of a disputed transaction; encoding the transaction details into transaction embeddings; analyzing the transaction embeddings; transforming the natural language embeddings and transaction embeddings into a natural language response according to the transaction prompt instruction; and transmitting the natural language response to a user interface.

Alternatively, or in addition to the other examples described herein, examples include any combination of the following:
repeatedly perform the operations of the executed by the processor or the method;
the datum of the transaction is incrementally presented in ascending order of sensitivity;
a first instance of the natural language response comprises data of a transaction amount, a date, a time, and a descriptor name of the transaction;
a second instance of the natural language response comprises contact information associated with the transaction;
a third instance of the natural language response comprises a location where the transaction was made;
a fourth instance of the natural language response comprises a listing of prior transactions of the user that were made with the same entity;
generate a summary of the transaction, the transaction history of the user, the natural language response, and a natural language answer received from the user;
present the summary of the transaction in the user interface;
the summary of the disputed transaction further comprises an instruction for the user to appeal the natural language answer to the transaction processor;
in response to a user dispute flag decision, automatically engage a heightened surveillance measure to monitor actions of the user for suspicious behavior;
adjusting a transaction request map based on analyzing the transaction embeddings, such that the generative model yields natural language responses that match by a threshold level with the responses associated with a transaction prompt instruction;
iteratively updating parameters of the generative model based on a difference between a predicted natural language output and a desired natural language output; and
the generative model comprises a trained regressor that is trained using the transaction details as feedback data.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

The benefits and advantages described above may relate to one embodiment or may relate to several embodiments. The embodiments are not limited to those that solve any or all of the stated problems or those that have any or all of the stated benefits and advantages. It will further be understood that reference to ‘an’ item refers to one or more of those items.

The embodiments illustrated and described herein as well as embodiments not specifically described herein but within the scope of aspects of the claims constitute exemplary means for

The term “comprising” is used in this specification to mean including the feature(s) or act(s) followed thereafter, without excluding the presence of one or more additional features or acts.

In some examples, the operations illustrated in the figures may be implemented as software instructions encoded on a computer readable medium, in hardware programmed or designed to perform the operations, or both. For example, aspects of the disclosure may be implemented as a system on a chip or other circuitry including a plurality of interconnected, electrically conductive elements.

The order of execution or performance of the operations in examples of the disclosure illustrated and described herein is not essential, unless otherwise specified. That is, the operations may be performed in any order, unless otherwise specified, and examples of the disclosure may include additional or fewer operations than those disclosed herein. For example, it is contemplated that executing or performing a particular operation before, contemporaneously with, or after another operation is within the scope of aspects of the disclosure.

When introducing elements of aspects of the disclosure or the examples thereof, the articles “a,” “an,” “the,” and “said” are intended to mean that there are one or more of the elements. The terms “comprising,” “including,” and “having” are intended to be inclusive and mean that there may be additional elements other than the listed elements. The term “exemplary” is intended to mean “an example of.” The phrase “one or more of the following: A, B, and C” means “at least one of A and/or at least one of B and/or at least one of C.”

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

What is claimed is:

1. A system for presenting a natural language response to a user query, the system comprising:
a user interface;
a processor; and
a computer storage medium storing instructions that are operative upon execution by the processor to:
receive, from a user, a query about a transaction;
gather, from a transaction database, transaction details of the user, wherein the transaction details comprise the transaction and a transaction history of the user;
send the transaction details and the query to a generative model, wherein the generative model is trained to present a natural language response to the user about the transaction;
receive, from the generative model, the natural language response, wherein the natural language response comprises a datum of the transaction;
present the natural language response to the user in the user interface; and
in an iterative fashion:
receive at least one additional query about the transaction; and
present at least one additional natural language response to the user in the user interface, wherein the at least one additional natural language response comprises an additional datum of the transaction.

2. The system of claim 1, wherein presenting the at least one additional natural language response prompts the user to cancel a dispute of the transaction or refrain from submitting a dispute of the transaction.

3. The system of claim 1, wherein the datum and the additional datum are presented in ascending order of sensitivity.

4. The system of claim 1, wherein the natural language response comprises data of a transaction amount, a date, a time, and a descriptor name of the transaction.

5. The system of claim 1, wherein a first instance of the at least one additional natural language response comprises contact information associated with the transaction.

6. The system of claim 5, wherein a second instance of the at least one additional natural language response comprises a location where the transaction was made.

7. The system of claim 6, wherein a third instance of the at least one additional natural language response comprises a listing of prior transactions of the user that were made with the same entity.

8. The system of claim 1, wherein the instructions are further operative to:
received a natural language answer from the user;
generate a summary of the transaction, the transaction history of the user, the natural language response, and the natural language answer; and
present the summary of the transaction in the user interface.

9. A system for flagging a user for a disputed transaction, the system comprising:
a processor; and
a computer storage medium storing instructions that are operative upon execution by the processor to:
receive, from a user, input for a disputed transaction;
gather, from a transaction database, transaction details of the user, wherein the transaction details comprise the disputed transaction and a transaction history of the user, wherein the transaction history comprises a total number of prior disputed transactions by the user and a corresponding outcome to each prior disputed transaction;
send the transaction details and the input to a generative model, wherein the generative model is trained to present a natural language response to the user about the disputed transaction;
receive, from the generative model, the natural language response, wherein the natural language response comprises a datum of the disputed transaction;
present the natural language response in a user interface, wherein the datum of the disputed transaction is presented as an icon;
receive, from the user, a natural language answer to the natural language response;
automatically determine, based on the natural language answer, the transaction history of the user, and a disputed transaction threshold, a user dispute flag decision, wherein the user dispute flag decision flags the user upon determining that the natural language answer and the total number of prior disputed transactions exceed the disputed transaction threshold; and
transmit the user dispute flag decision to a transaction processor.

10. The system of claim 9, wherein the instructions are further operative to:
generate a summary of the disputed transaction, the transaction history of the user, the natural language response, and the natural language answer; and
present the summary of the disputed transaction in the user interface.

11. The system of claim 10, wherein the summary of the disputed transaction further comprises an instruction for the user to appeal the natural language response to the transaction processor.

12. The system of claim 9, wherein a first instance of the natural language response comprises data of a transaction amount, a date, a time, and a descriptor name of the disputed transaction.

13. The system of claim 12, wherein a second instance of the natural language response comprises contact information associated with the disputed transaction.

14. The system of claim 13, wherein a third instance of the natural language response comprises a location where the disputed transaction was made.

15. The system of claim 14, wherein a fourth instance of the natural language response comprises a listing of prior transactions of the user that were made with the same entity.

16. The system of claim 9, wherein the instructions are further operative to:
in response to the user dispute flag decision, automatically engage a heightened surveillance measure to monitor actions of the user for suspicious behavior.

17. A computerized method for training and operating a generative language model, the method comprising:
obtaining natural language embeddings from a database;
receiving a transaction prompt instruction from a model training system;
receiving transaction details of a user, wherein the transaction details comprise a transaction history of the user and data of a disputed transaction;
encoding the transaction details into transaction embeddings;
analyzing the transaction embeddings;
transforming the natural language embeddings and transaction embeddings into a natural language response according to the transaction prompt instruction; and
transmitting the natural language response to a user interface.

18. The method of claim 17, further comprising:
adjusting a transaction request map based on analyzing the transaction embeddings, such that the generative language model yields natural language responses that match by a threshold level with the responses associated with a transaction prompt instruction.

19. The method of claim 17, further comprising:
iteratively updating parameters of the generative language model based on a difference between a predicted natural language output and a desired natural language output.

20. The method of claim 17, wherein the generative language model comprises a trained regressor that is trained using the transaction details as feedback data.
